(19) United States
(12) Patent Application Publication
(10) Pub. No.: US 2008/0240517 A1
(43) Pub. Date: Oct. 2, 2008

(54) IMAGE PROCESSING APPARATUS

(75) Inventor: Masayoshi OKAMOTO, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SANYO ELECTRIC CO., LTD., Osaka (JP)

(21) Appl. No.: 12/055,864

(22) Filed: Mar. 26, 2008

(30) Foreign Application Priority Data
Mar. 27, 2007 (JP) 2007-080565

(51) Int. Cl. G06K 9/00

(52) U.S. Cl. 382/118

(57) ABSTRACT

An image processing apparatus includes an imaging device, and image data representing an object scene captured by the imaging device is retained in an SDRAM. A CPU recognizes a facial image of a person from the retained image data. The CPU further specifies a partial background image being a background of a head of the person out of a background image of the person from the same image data on the basis of a recognition result of the facial image. Blurring processing is executed on the specified partial background image.

### CROSS REFERENCE OF RELATED APPLICATION

The disclosure of Japanese Patent Application No. 2007-80565 is incorporated herein by reference.

### BACKGROUND OF THE INVENTION

1. Field of the Invention

The present invention relates to an image processing apparatus. More specifically, the present invention relates to an image processing apparatus which is applied to an electronic camera, and performs blurring processing on a background image.

2. Description of the Related Art

In one example of a related art of this kind of an apparatus, image data representing a background area except for a person out of image data representing an object scene captured by an imaging device is subjected to processing for suppressing a high spacial frequency component. Such image data of the background area on which the suppressing processing is performed is combined with the image data of the person to thereby produce a portrait image.

However, in general, detection accuracy of a torso image of a person tends to be lower than that of a head image of a person. In other words, for detecting the torso image of the person, ability higher than that required to detect a head image of the person is required. Thus, in the related art, it may take much time to produce a portrait image.

Therefore, it is a primary object of the present invention to provide a novel image processing apparatus.

### SUMMARY OF THE INVENTION

An image processing apparatus in one aspect of the present invention comprises: a recognizer for recognizing a facial image of a person from an object scene image, a specifier for specifying a partial background image being a background of a head of the person out of a background image of the person from the object scene image on the basis of a recognition result of the recognizer, and a blurring processor for performing blurring processing on the partial background image specified by the specifier.

A facial image of a person is recognized from an object scene image by a recognizer. A specifier specifies a partial background image being a background of a head of the person out of a background image of the person from the object scene image on the basis of a recognition result of the recognizer. A blurring processor performs blurring processing on the partial background image specified by the specifier.

Detection accuracy of an outline of a head of a person generally tends to be higher than that of an outline of a torso of the person. Furthermore, a background surrounding a head of a person generally tends to be farther than a background surrounding a torso of the person. Hence, in the present invention, a partial background image being a background of a head of a person is specified from an object scene image, and blurring processing is performed on the specified partial background image. Thus, it is possible to easily produce an image in which the background is blurred.

The above described objects and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing a configuration of one embodiment of the present invention.

FIG. 2 is an illustrative view showing one example of an object scene image captured by FIG. 1 embodiment.

FIG. 3 is an illustrative view showing a relationship between a facial image frame and a head surrounding image frame.

FIG. 4(A) is an illustrative view showing one example of a head surrounding image extracted from the object scene image shown in FIG. 2, and FIG. 4(B) is an illustrative view showing one example of processing performed on the head surrounding image shown in FIG. 4(A).

FIG. 5 is an illustrative view showing a blurred area and a non-blurred area assigned to the object scene image shown in FIG. 2.

FIG. 6 is a graph showing a change of a degree of blur with respect to a vertical position of the object scene image.

FIG. 7 is a flowchart showing a part of an operation of a CPU applied to FIG. 1 embodiment.

FIG. 8 is a flowchart showing another part of the operation of the CPU applied to FIG. 1 embodiment.

FIG. 9 is an illustrative view showing another example of the blurred area and the non-blurred area assigned to the object scene image shown in FIG. 2.

FIG. 10 is an illustrative view showing another example of processing performed on the head surrounding image shown in FIG. 4(A).

FIG. 11 is a flowchart showing a still another part of the operation of the CPU applied to FIG. 1 embodiment.

### DETAILED DESCRIPTION OF THE PREFERRED EMBODIMENTS

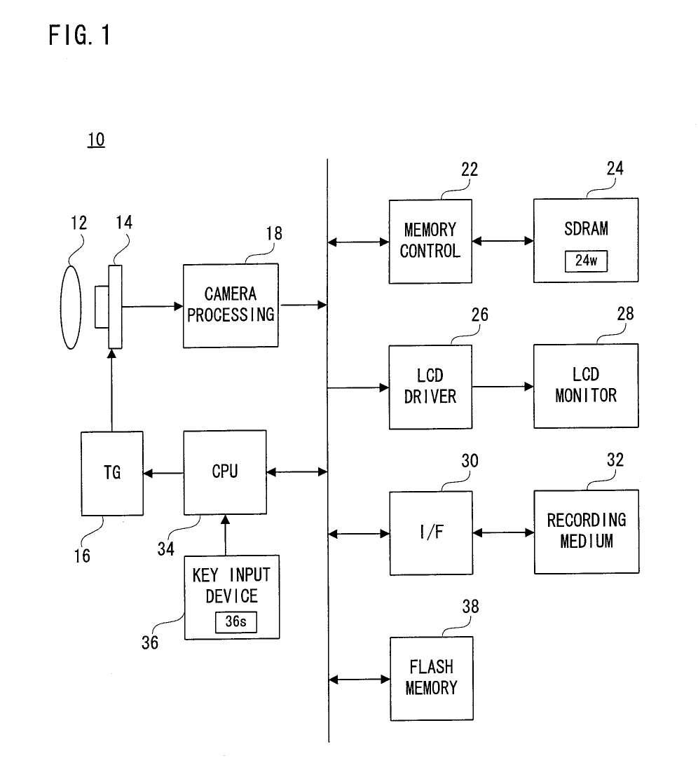

Referring to FIG. 1, a digital camera 10 of this embodiment includes an optical lens 12. An optical image representing an object scene is irradiated onto an imaging surface of an imaging device 14 through the optical lens 12. The imaging surface is covered with a color filter (not shown) on which color elements of R (Red), G (Green) and B (Blue) are arranged in a mosaic manner. An amount of the electric charge generated in each of a plurality of photoreceptors formed on the imaging surface reflects an amount of such a light passing through the color filter. That is, the electric charge generated in each of the photoreceptors has color information of R, G or B.

When a camera mode is selected by a key input device 36, a CPU 34 instructs a TG 16 to repetitively perform a pre-exposure and a thinning-out reading in order to execute through image processing, and instructs an LCD driver 28 to execute displaying processing. The TG 16 performs a pre-exposure on the imaging surface for every 1/30 seconds, and reads a part of the electric charges thus generated from the imaging surface in a raster scanning manner. Thus, a low-resolution raw image signal representing the object scene is output from the imaging device 14 at a frame rate of 30 fps.

A camera processing circuit 18 performs a series of processing of a CDS, AGC, A/D conversion, a color separation, a white balance adjustment and a YUV conversion on a raw image signal of each frame output from the imaging device 14 to generate image data in a YUV format. The generated image data is written to an SDRAM 24 by a memory control circuit 22. An LCD driver 26 reads the image data stored in the SDRAM 24 through the memory control circuit 22 for each 1/30 seconds, and drives the LCD monitor 28 on the basis of the read image data. Thus, a through-image of the object scene is displayed on the monitor screen.

The CPU 34 takes a Y component of the image data generated by the camera processing circuit 18, and performes an AE processing for through image on the basis of the taken Y component. Thus, a pre-exposure for an appropriate time is executed, and brightness of the through-image displayed on the LCD monitor 28 is moderately adjusted.

When a shutter button 36s on the key input device 36 is half-depressed, AE processing for recording image is executed by the CPU 34 in order to strictly adjust the pre-exposure time. The pre-exposure time is set to an optimum time.

When the shutter button 36s on the key input device 36 is fully-depressed, the CPU 34 instructs the TG 16 to execute a single primary exposure and a single all-pixel-reading, and instructs an I/F circuit 30 to execute recording processing. The TG 16 performs a primary exposure on the imaging surface for an optimum time, and reads all the electric charges thus generated from the imaging surface in a raster scanning manner. Thus, a high-resolution raw image signal representing the object scene at a time that the recording operation is performed is output from the imaging device 14. The output raw image signal is subjected to the processing described above by the camera processing circuit 18, and image data in a YUV format thus generated is written to the SDRAM 24 by the memory control circuit 22. The I/F circuit 30 reads high-resolution image data thus retained in the SDRAM 24 through the memory control circuit 22, and records the read image data in a recording medium 32 in a file format.

When a reproduction mode is selected by the key input device 36, the CPU 34 instructs the I/F circuit 30 to reproduce a desired file, and instructs the LCD driver 26 to execute a displaying processing. The I/F circuit 30 accesses the recording medium 32 to reproduce image data stored in the desired file. The reproduced image data is written to the SDRAM 24 by the memory control circuit 22. The LCD driver 26 reads the image data stored in the SDRAM 24 through the memory control circuit 22, and drives the LCD monitor 28 on the basis of the read image data. Thus, a reproduction image is displayed on the monitor screen.

When a background blurring mode is selected by the key input device 36 in a camera mode or a reproduction mode, blurring processing as described below is performed on the high-resolution image data retained in the SDRAM 24 as a processing objective image.

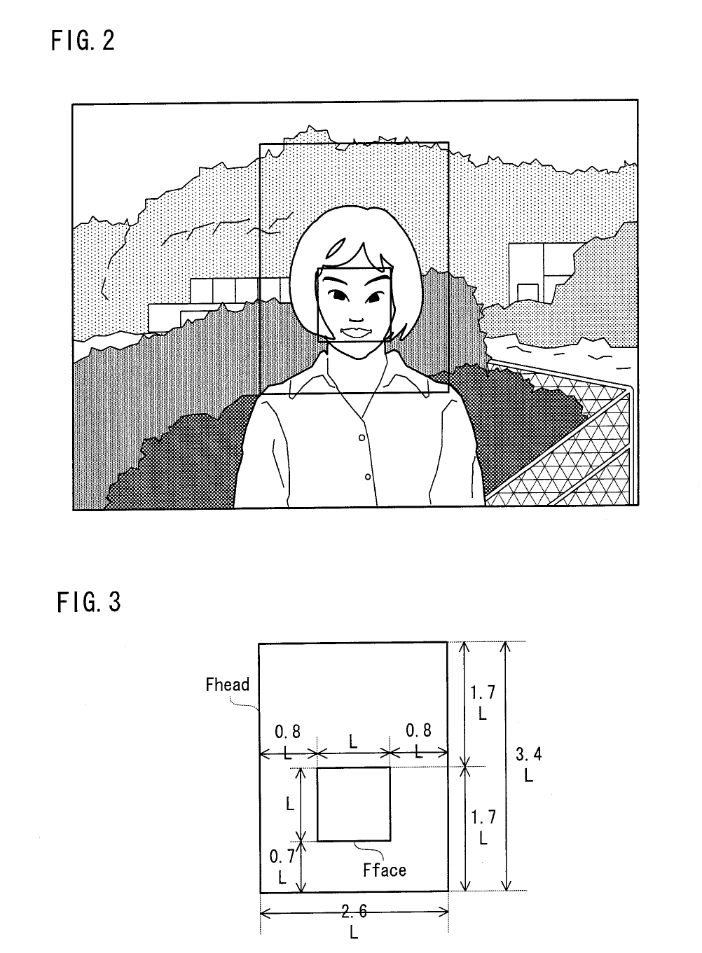

In a case that the processing objective image is an object scene image shown in FIG. 2, a facial image of a person H1 is first recognized by face recognizing processing. A square facial image frame Fface is assigned to the recognized facial image. Two parallel sides defining the square extend in a horizontal direction, and the other two sides extend in a vertical direction. Around the facial image frame Fface, a rectangular head surrounding image frame Fhead which satisfies a position and a size shown in FIG. 3 is assigned.

Referring to FIG. 3, when a length of one side defining the facial image frame Fface is regarded as “L”, a length of a long side defining the head surrounding image frame Fhead is regarded as “3.4L”, and a length of a short side defining the head surrounding image frame Fhead is regarded as “2.6L”. Here, the side extending in a vertical direction corresponds to the long side, and the side extending in a horizontal direction corresponds to the short side. The horizontal center of the facial image frame Fface corresponds to the horizontal center of the head surrounding image frame Fhead. Furthermore, each of the distances from the one upper side out of the two horizontally sides defining the facial image frame Fface to the two short sides defining the head surrounding image frame Fhead corresponds to “1.7L”.

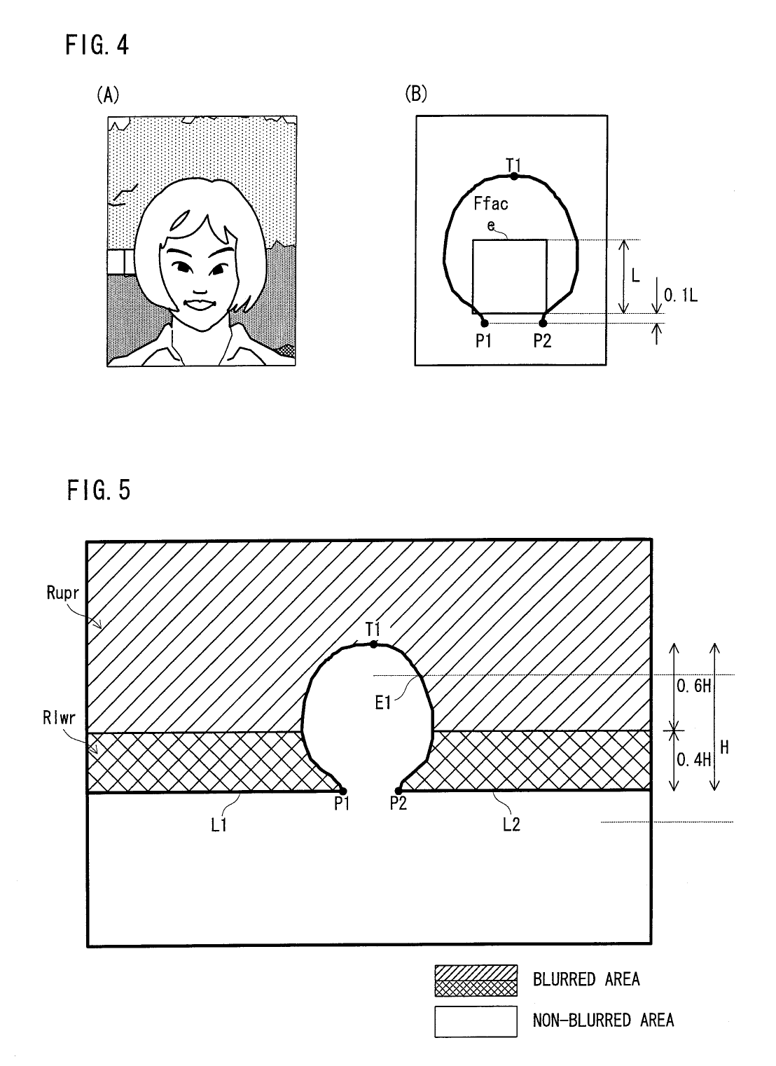

A partial image belonging to the head surrounding image frame Fhead, that is, a head surrounding image is copied in a work area 24w on the SDRAM 24 as shown in FIG. 4(A). Then, an outline of the head is detected by edge detecting processing as shown in FIG. 4(B). In addition, two reference points P1 and P2 are assigned to the detected outline of the head. Each of the assignment position of the reference points P1 and P2 is a position downwardly apart from the lower side defining the facial image frame Fface by “0.1L”.

After completion of the assignment of the reference points P1 and P2, lines L1 and L2 horizontally and outwardly extending from the reference points P1 and P2 respectively, and a head's outline E1 are drawn on the processing objective image. A blurred area is an image area above the drawn lines L1, L2 and the head's outline E1. In other words, an image area below the lines L1, L2 and the head's outline E1 is a non-blurred area.

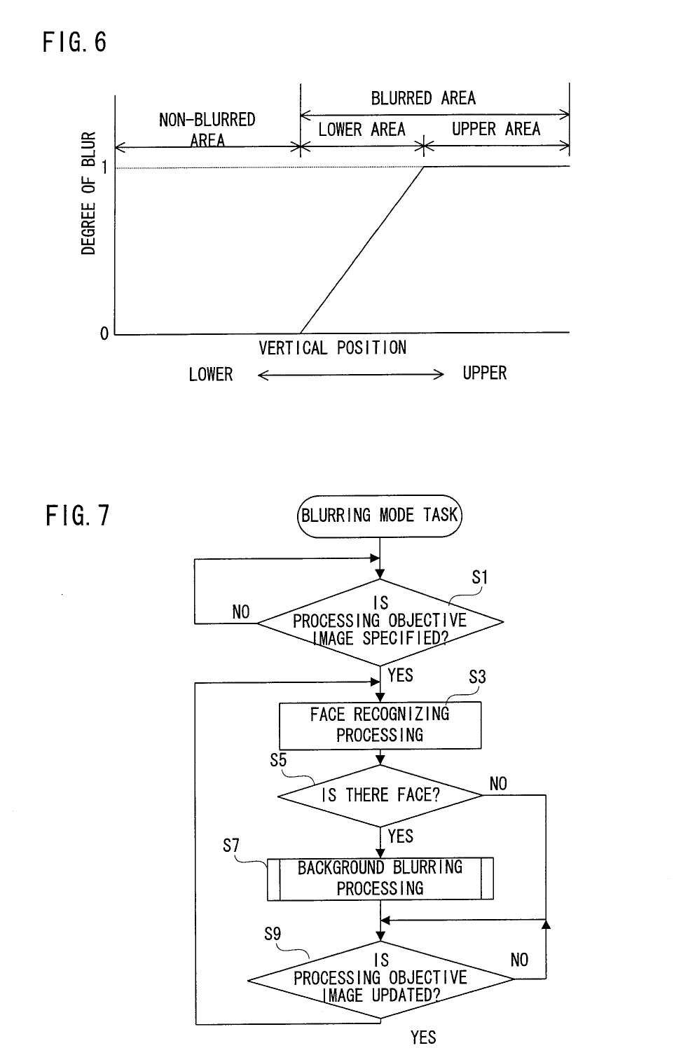

The blurred area is then divided into an upper area Rupr and a lower area Rlwr with reference to a top T1 of the head's outline, and blurring processing in a different manner is performed on each of the upper area Rupr and the lower area Rlwr. That is, referring to FIG. 6, blurring processing according to a degree of blur “1” is performed on the upper area Rupr while blurring processing according to “0”-“1” is performed on the lower area Rlwr. The degree of blur of the lower area Rlwr is linearly increased from “0” to “1” from below to above.

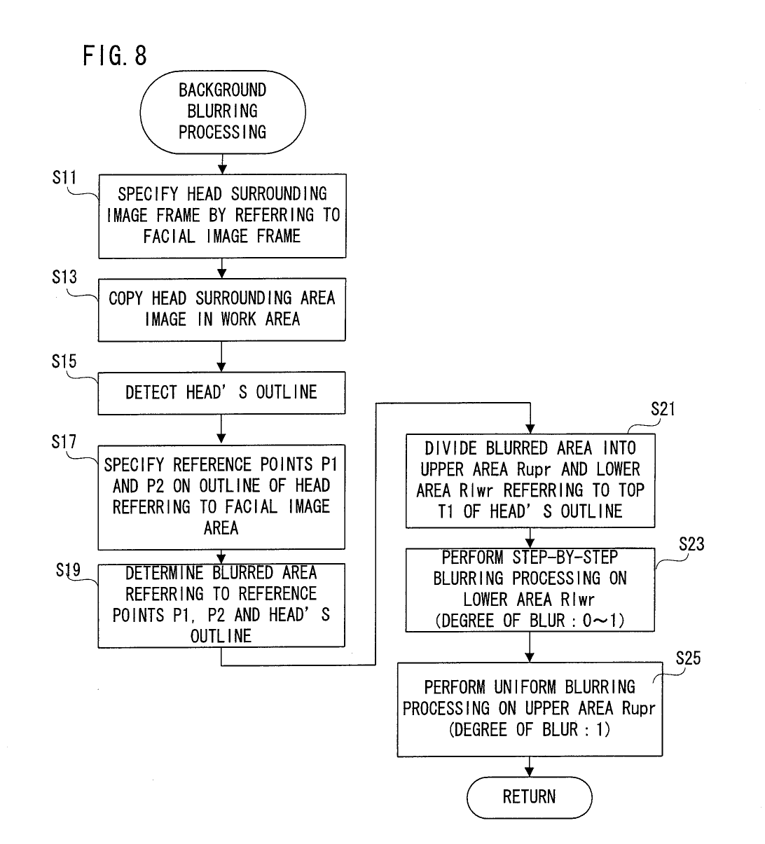

The CPU 34 executes background blurring task shown in FIG. 7-FIG. 8 when a background blurring mode is selected. The control program corresponding to the task is stored in a flash memory 38.

First, it is determined whether or not a processing objective image is specified in a step S1. In the camera mode, in response to the shutter button 36s being fully depressed, the high-resolution image data retained in the SDRAM 24 corresponds to the processing objective image. Furthermore, in the reproduction mode, the high-resolution image data reproduced from the desired file corresponds to the processing objective image. If “YES” in the step S1, face recognizing processing is executed in a step S3. More specifically, dictionary data corresponding to eyes, a nose, a mouth of a person is checked against the processing objective image to thereby recognize a facial image of the person. When the recognition of the facial image is unsuccessful, the process proceeds to a step S9 as it is while when the recognition of the facial image is successful, background blurring processing is executed in a step S7, and the process proceeds to the step S9. In the step S9, it is determined whether or not the processing objective image is updated, and when the determination result is updated from “NO” to “YES”, the process returns to the step S3.

The background blurring processing in the step S7 complies with a subroutine shown in FIG. 8. First, in a step S11, a head surrounding image frame Fhead is specified referring to the facial image frame Fface specified by the face recognizing processing. In a step S13, a partial image belonging to the head surrounding image frame Fhead, that is, a head surrounding area image is copied in the work area 24w on the SDRAM 24. In a step S15, a head's outline is detected from the copied head surrounding image. In a step S17, reference points P1 and P2 on the head's outline are specified with reference to the facial image frame Fface, and in a step S19, a blurred area is specified with reference to the specified reference points P1 and P2.

In a step S21, with reference to a top T1 on the head's outline, the blurred area is divided into an upper area Rupr and a lower area Rlwr. In a step S23, step-by-step-blurring processing (a degree of blur: 0-1) is executed on the lower area Rlwr, and in a step S25, uniform blurring processing (a degree of blur: 1) is executed on the upper area Rupr. After completion of the processing in the step S25, the process is restored to the routine at the hierarchical upper level.

As understood from the above description, a facial image of the person is recognized from the object scene image by the CPU 34 (S3). The CPU 34 specifies a partial background image being a background of the head out of the background image of the person from the object scene image on the basis of the recognition result of the facial image (S17, S19). The blurring processing is performed on the specified partial background image (S23, S25).

Detection accuracy of an outline of a head of a person generally tends to be higher than detection accuracy of an outline of a torso of the person. Furthermore, a background surrounding a head of a person generally tends to be farther than a background surrounding a torso of the person. Hence, in the present invention, a partial background image being a background of a head of a person is specified from an object scene image, and blurring processing is performed on the specified partial background image. Thus, it is possible to easily produce an image in which the background is blurred.

Additionally, in this embodiment, a lower edge of the blurred area is defined by the lines L1 and L2 outwardly and horizontally extending from the reference points P1 and P2, but in place of this, the lower edge of the blurred area may be defined by lines L1′ and L2′ extending obliquely downwardly from the reference points P1 and P2 (see FIG. 9). In this case, background blurring processing is preferable in which an area above the lines L1 and L2 is regarded as an upper area Rupr while an area sandwiched with the lines L1 and L1′ and an area sandwiched with the lines L2 and L2′ are regarded as a lower area Rlwr.

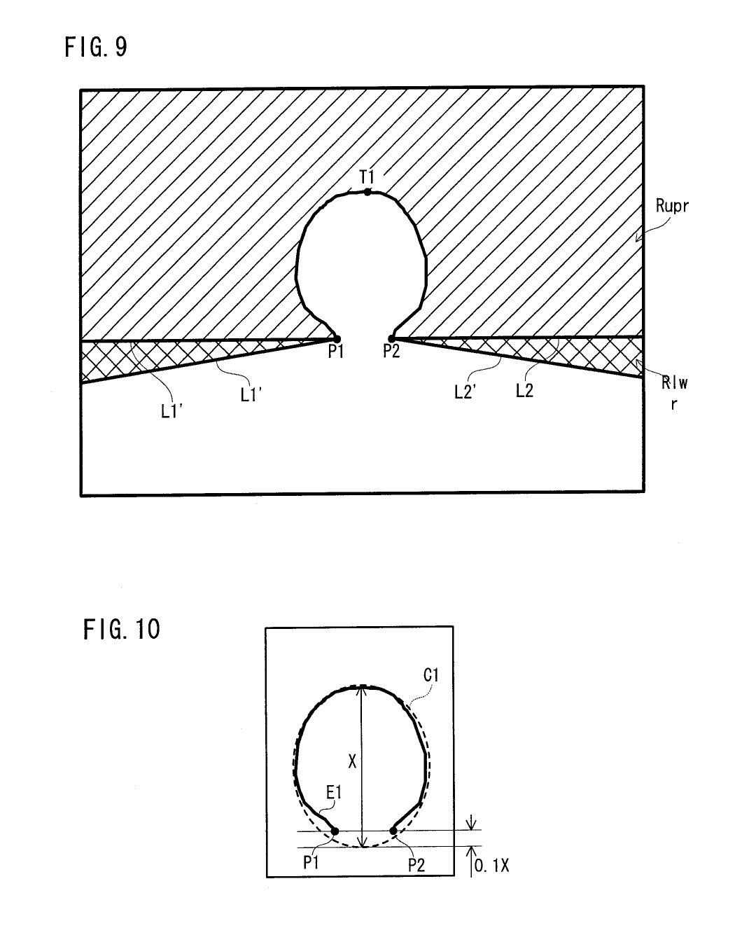

Furthermore, in this embodiment, each of the reference points P1 and P2 is assigned to a position downwardly apart from the lower side defining the facial image frame Fface by “0.1L”. However, an ellipse C1 (major diameter: X) circumscribing the head's outline E1 is defined, and each of the reference points P1 and P2 is assigned to a position upwardly apart from the lower edge of the ellipse C1 by 0.1X (see FIG. 10).

In addition, in this embodiment, background blurring processing is performed on image data to be recorded in the recording medium 32 or image data reproduced from the recording medium 32. However, the background blurring processing may be performed on low-resolution image data forming a through-image. Specifically, if background blurring processing is executed in response to the shutter button 36s being half-depressed, it is easily determine what kind of recording image can be obtained with respect to the object scene currently captured, capable of improving operability. Furthermore, in this embodiment, only the image data on which background blurring processing is performed is recorded in the recording medium 32, but in addition thereto, normal image data on which background blurring processing is not performed may be recorded in the recording medium 32.

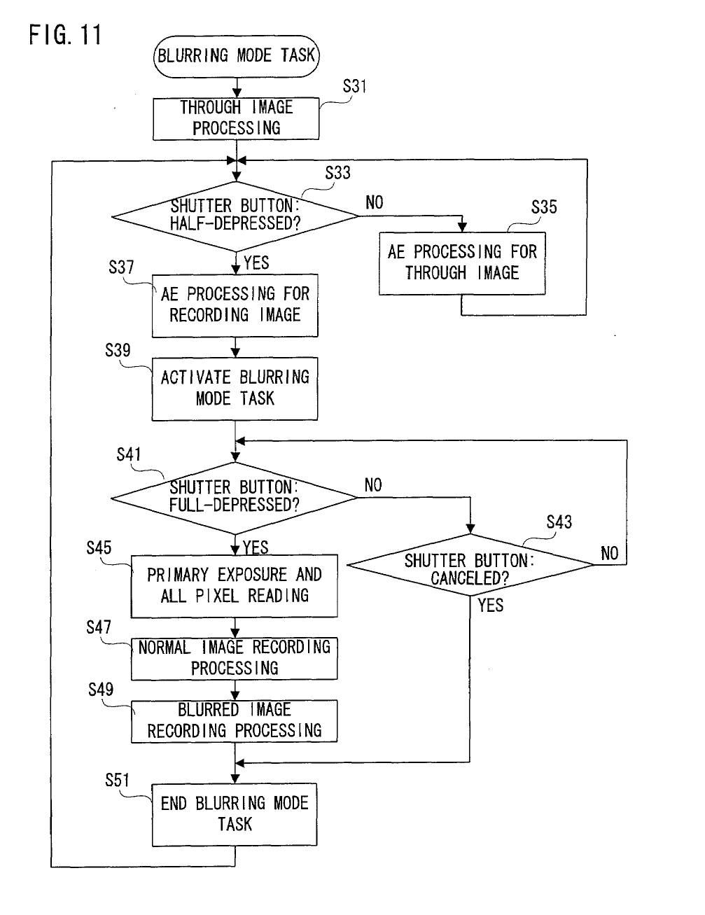

The processing of performing background blurring processing in response to the shutter button 36s being half-depressed, and the processing of performing recording processing of normal image data and image data on which the background blurring processing is performed in response to the shutter button 36s being fully-depressed are executed according to a flowchart shown in FIG. 11.

Referring to FIG. 11, in a step S31, through image processing is executed. Thus, a through-image is displayed on the LCD monitor 28. In a step S33, it is determined whether or not the shutter button 36s is half-depressed, and if “NO”, AE processing for through image in a step S35 is repeated. When the shutter button 36s is fully-depressed, “YES” is determined in the step S33, and in a step S37, AE processing for recording image is executed, and in a step S39, a blurring mode task is activated. As a result of the blurring mode task being activated, a through-image on which the background blurring processing is performed is output to the LCD monitor 28.

In a step S41, it is determined whether or not the shutter button 36s is fully-depressed. In a step S43, it is determined whether or not an operation of the shutter button 36s is cancelled. If “YES” in the step S41, the TG 16 is instructed to execute a single primary exposure and a single all-pixel reading in a step S45. In a step S47, the I/F circuit 30 is instructed to perform recording processing of the normal image data, and in a step S49, the I/F circuit 30 is instructed to perform recording processing of the image data on which the background blurring processing is performed. After completion of the step S49, in a step S51, the blurring mode task is ended, and then the process returns to the step S33. If “YES” in the step S43, the process returns to the step S33 through the processing in the step S51.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An image processing apparatus comprising:
a recognizer for recognizing a facial image of a person from an object scene image;
a specifier for specifying a partial background image being a background of a head of said person out of a background image of said person from said object scene image on the basis of a recognition result of said recognizer; and
a blurring processor for performing blurring processing on the partial background image specified by said specifier.

2. An image processing apparatus according to claim 1, further comprising a detector for detecting an outline of the head of said person from a partial image surrounding the facial image recognized by said recognizer, wherein
said specifier specifies said partial background image with reference to the outline detected by said detector.

3. An image processing apparatus according to claim 2, wherein said specifier includes a first definer for providing a definition by a line horizontally extending along a lower edge of said partial background image.

4. An image processing apparatus according to claim 2, wherein said specifier includes a second difiner for providing a definition by a line extending obliquely downwardly and outwardly along a lower edge of said partial background image.

5. An image processing apparatus according to claim 1, wherein said blurring processor increases a degree of blurring of said partial background image upwardly.

6. An image processing apparatus according to claim 1, further comprising an imager for producing an object scene image, and
a writer for writing the object scene image produced by said imager into a memory, wherein
said recognizer executes recognizing processing with respect to the object scene image stored in said memory by said writer.

7. An image processing apparatus according to claim 6, further comprising a reader for reading the object scene image stored in said memory by said writer for displaying processing on a monitor, wherein
said imager repeatedly produces said object scene image.

8. An image processing apparatus according to claim 7, further comprising:
an adjuster for adjusting an imaging condition in response to a condition adjustment operation; and
an activator for activating said blurring processor in association with the adjusting processing by said adjuster.

9. An image processing apparatus according to claim 1, further comprising:
a first recorder for recording the object scene image stored in said memory by said writer in a recording medium in response to a recording operation; and
a second recorder for recording an object scene image having a partial background image on which blurring processing is performed by said blurring processor in said recording medium in association with the recording processing by said first recorder.

10. An computer-readable recording medium including an image processing program, said image processing program causes a processor of an image processing apparatus to execute
a recognizing step for recognizing a facial image of a person from an object scene image,
a specifying step for specifying a partial background image being a background of a head of said person out of a background image of said person from said object scene image on the basis of a recognition result of said recognizing step, and
a blurring processing step for performing blurring processing on the partial background image specified by said specifying step.

11. An image processing method executed by an image processing apparatus, including following steps of:
a recognizing step for recognizing a facial image of a person from an object scene image;
a specifying step for specifying a partial background image being a background of a head of said person out of a background image of said person from said object scene image on the basis of a recognition result of said recognizing step; and
a blurring processing step for performing blurring processing on the partial background image specified by said specifying step.
